(19) United States
(12) Patent Application Publication
(10) Pub. No.: US 2007/0063640 A1
(43) Pub. Date: Mar. 22, 2007

(54) Electroluminescent display panel

(75) Inventors: Paulus Cornelis Duineveld, Drachten (NL); Michel Marcel Jose Decre, Eindhoven (NL); Giovanni Nisato, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,430

(22) PCT Filed: Oct. 6, 2004
(86) PCT No.: PCT/IB04/51993

§ 371 Date: Apr. 10, 2006

(30) Foreign Application Priority Data
Oct. 13, 2003 (EP) 03103773.2

(51) Int. Cl. H01J 1/62; H01J 63/04

(52) U.S. Cl. 313/506

(57) ABSTRACT

The invention relates to an electroluminescent display panel (2) comprising a substrate and a plurality of display pixels (3) including an electroluminescent material defined on or over said substrate. The display panel (2) further includes at least one microcontact printed hydrophobic layer (11) between adjacent display pixels (3). The invention further relates to a method for manufacturing such a display panel. The method avoids the need to apply photoresist barriers for containing the liquid electrolumi-nescent material.

The invention relates to an electroluminescent display panel comprising a substrate and a plurality of display pixels including an electroluminescent material defined on or over said substrate.

Display panels employing display pixels comprising electroluminescent material on or over a substrate are becoming increasingly popular. These light emitting elements may be light emitting diodes (LED's), incorporated in or forming the display pixels that are arranged in a matrix of rows and columns. The materials employed in such LED's are suitable to generate light if a current is conveyed through these materials, such as particular polymeric (PLED) or small molecule organic (SMOLED) materials. Accordingly the LED's have to be arranged such that a flow of current can be driven through these electroluminescent materials. Typically passively and actively driven matrix displays are distinguished. For active matrix displays, the display pixels themselves comprise active circuitry such as one or more transistors.

PLED materials provide advantages over SMOLED materials due to their intrinsic characteristics of thermal stability, flexibility and solubility in aqueous solutions or solvents. As a result PLED materials can be applied by wet chemical techniques such as spincoating or ink jet deposition.

EP-A-0 892 028 discloses an organic EL element wherein transparent pixel electrodes are formed on a transparent substrate. Photolithographically defined photoresist banks are formed between the pixel electrodes to prevent a liquid ink drop comprising electroluminescent material to unintentionally flow to adjacent display pixels.

The manufacturing process for such an electroluminescent display panel involves the application of elevated temperatures. These elevated temperatures are required to crosslink the photoresist material and/or to smoothen the photoresist banks as a metallic layer is usually deposited over the structure to provide an electrode for the displays pixels. Typically the temperature is elevated above the glass temperature of the photoresist material employed. Moreover, for passive matrix display panels additional photoresist structures are usually applied for separation of the metallic electrode layer. For these passive matrix display panels the elevation of the temperature is required to crosslink the photoresist before the additional photoresist structure is deposited.

However, the required elevation of the temperature in the manufacturing process is disadvantageous. For instance, if a flexible substrate is used, elevated temperatures may induce or result in a considerable dimensional distortion of such a substrate. Further, the photoresist banks typically give rise to considerable distances between the display pixels as these banks are usually applied by standard proximity lithography suffering from optical diffraction limitations. Moreover, lithography is a costly process step making such a display panel more expensive. Further, the photoresist banks require an additional non-wetting plasma treatment step to prevent printed ink drops to mix with adjacent display pixels.

It is an object of the invention to provide an electroluminescent display panel wherein at least one of the above-mentioned disadvantages is reduced or eliminated.

This object is achieved by providing an electroluminescent display panel wherein said display panel further includes at least one microcontact printed hydrophobic layer between adjacent display pixels. The application of a microcontact printed hydrophobic layer eliminates the need for photoresist banks to prevent mixing of the liquid ink drops with electroluminescent material and thus the need to smoothen the banks, i.e. to induce a curvature for the initially sharp edges of the photolithographically defined banks, by an elevated temperature. Microcontact printing does not require temperature elevation. Further, a microcontact printed layer increases the effective display pixel area that contributes to light emission as the resolution is better than for display pixels defined by standard proximity lithography. Moreover, microcontact printed layers avoid the need for a photolithographically defined photoresist bank yielding lower cost display panels. It is noted that a microcontact printed hydrophobic layer includes a microcontact printed layer that has obtained or improved its hydrophobic character after printing, e.g. by fluorination of the printed layer.

In an embodiment of the invention the hydrophobic layer is a self-assembling monolayer. Such a monolayer has been found to have poor wetting characteristics for inkjet printed liquid drops comprising electroluminescent material, i.e. the liquid or fluid has a high advancing contact angle with such a monolayer. It is noted that the liquid may comprise a conducting polymer, e.g. polyaniline (PANI)or poly-3,4-ethylenedioxythiophene (PEDOT) or a light emitting substance comprising an electroluminescent material or a precursor material thereof. The fluid can e.g. be a solution, dispersion or emulsion. It can, e.g. include a soluble polymer that exhibits electroluminescence.

In an embodiment of the invention the substrate is a flexible substrate. This flexible substrate may be either a transparent plastic or a non-transparent metal foil. Such substrates are advantageous as the provide form freedom and a much thinner display panel.

In a preferred embodiment of the invention the display panel further comprises first and second electrodes for said display pixels and a protection layer isolating or separating said first and second electrodes between said display pixels. The protection layer may be either an anorganic layer, such as silicondioxide, or an organic layer. The protection layer is sufficiently thick to isolate the first and second electrodes outside the pixel areas. The microcontact printed hydrophobic layer may be defined on or over this protection layer. Preferably the microcontact printed hydrophobic layer exposes a part of said protection layer to said electroluminescent material. As the protection layer is preferably hydrophilic such an arrangement improves the homogeneous spread of the liquid in the display pixel avoiding reduced thickness of the electroluminescent material layer near the boundaries of the display pixel.

The invention further relates to an electric device comprising a display panel as described above. Such an electric device may relate to handheld devices such as a cellular phone, a Personal Digital Assistant (PDA) or a portable computer as well as to devices such as a monitor of a personal computer, a television set or a display on e.g. a dashboard of a car.

The invention further relates to a method for manufacturing an electroluminescent display panel comprising the steps of:

providing a substrate;

providing a hydrophobic layer on or over said substrate by microcontact printing

These steps yield a low cost manufacturing method wherein photoresist barriers are no longer required in order to separate deposited liquids with electroluminescent material. The method may include further steps to manufacture the display panel. One of these steps may be a fluorination step of a microprinted material giving rise to or improving the hydrophobic character of the layer.

In an embodiment of the method the hydrophobic layer is printed on a polymer layer, that may be a polymer substrate or a polymer layer on a polymer substrate or substrate of another material. Such a polymer layer may e.g. be used as a protection layer for insulating the electrodes on the display panel. Several systems for microprinting on polymer interfaces are described in the subclaims.

It is noted that microcontact printing in displays as such is known from US 2002/0051893. However, in this disclosure a conductive material is printed on an inorganic or organic film for use as a cathodic contact. Further it is known from U.S. Pat. No. 6,380,101 to provide microcontact printed self-assembling monolayers on indium zinc oxide as a protection against wet chemical etching.

The invention will be further illustrated with reference to the attached drawings, which show a preferred embodiment according to the invention. It will be understood that the invention is not in any way restricted to these specific and preferred embodiments.

In the drawings:

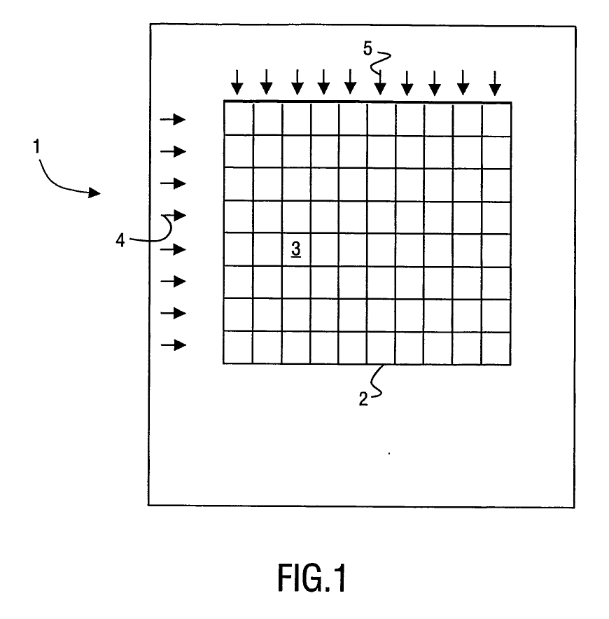

FIG. 1 shows an electric device comprising a display panel;

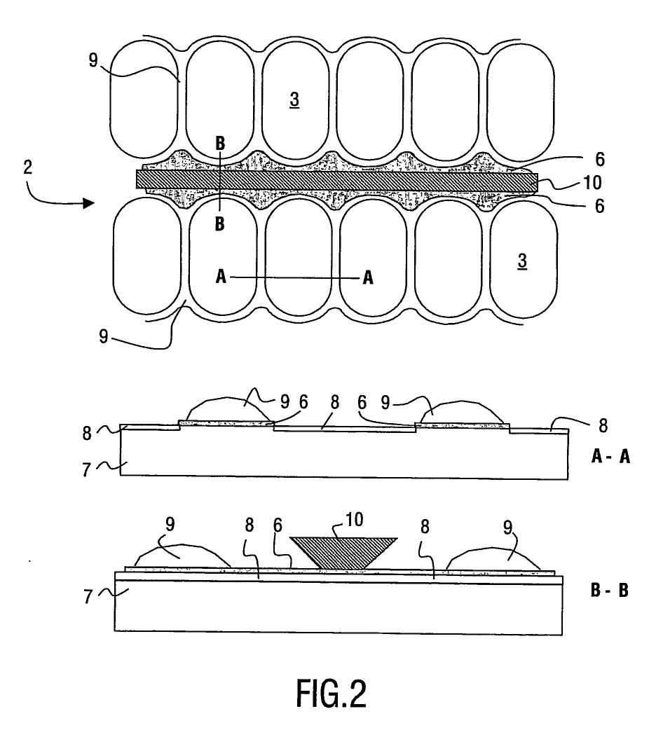

FIG. 2 shows a part of a passive matrix display panel in top view and along cross-sections A-A and B-B according to the prior art;

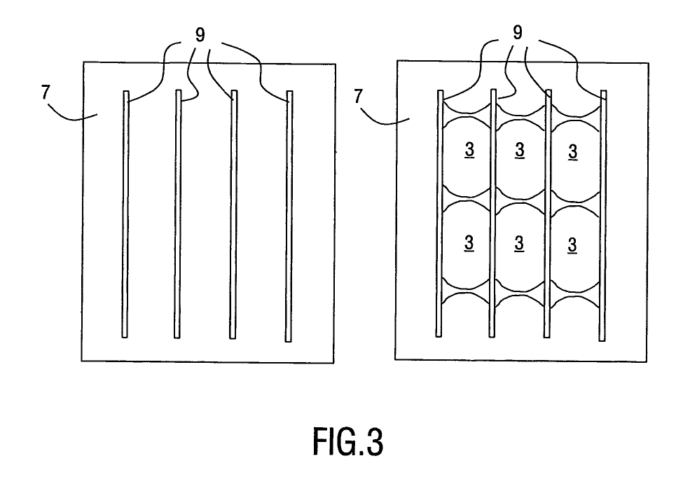

FIG. 3 shows a part of an active matrix display panel according to the prior art;

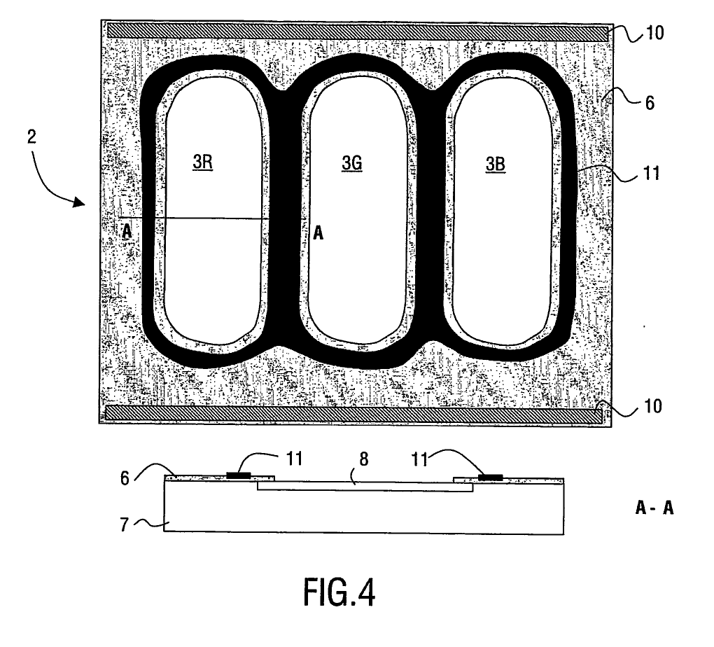

FIG. 4 shows a part of a passive matrix display panel in top view and along cross-section A-A according to an embodiment of the invention;

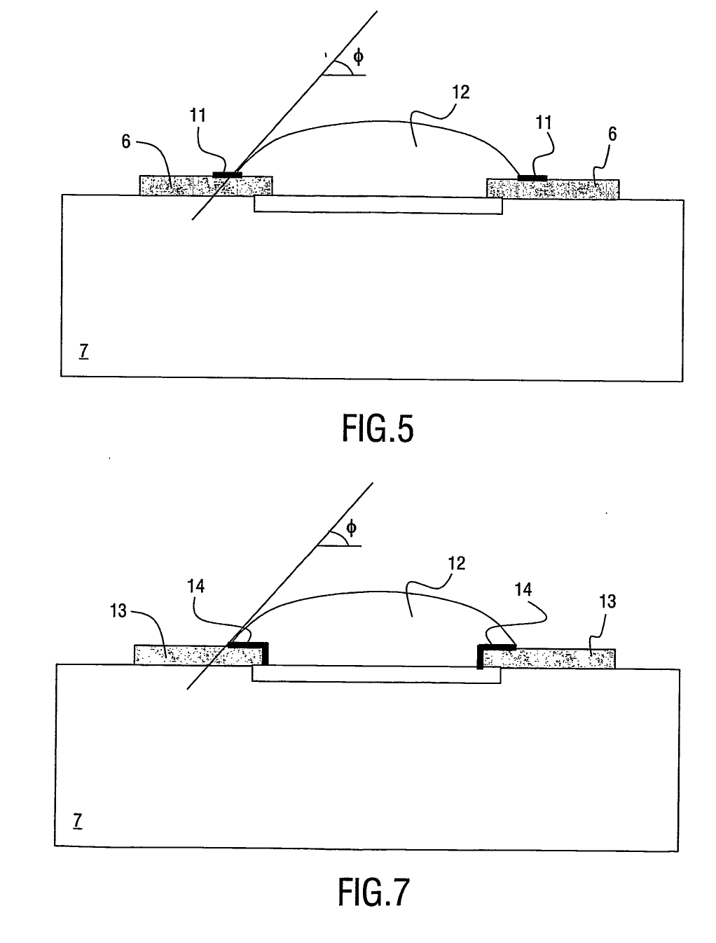

FIG. 5 shows an illustration of a liquid drop comprising electroluminescent material on a display panel according to an embodiment of the invention;

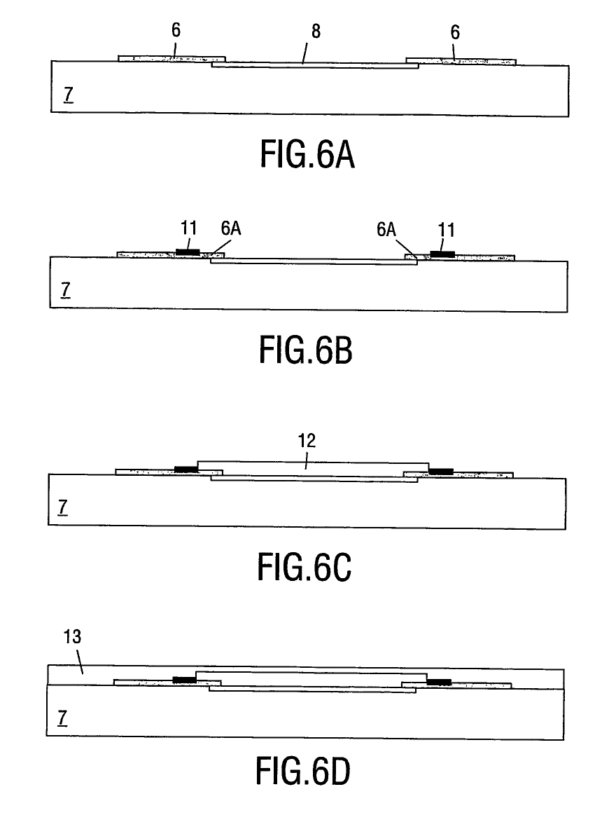

FIGS. 6A-6D show several steps of the manufacturing process according to an embodiment of the invention;

FIG. 7 shows an illustration of a liquid drop comprising electroluminescent material on a display panel according to a “negative printing” embodiment of the invention.

FIG. 1 shows an electric device 1 comprising an active display panel 2 having a plurality of display pixels 3 arranged in a matrix of rows 4 and columns 5. The display panel 2 may be an active matrix display or a passive matrix display comprising display pixels 3 containing organic light emitting diodes (OLEDs) The display panel 2 may be a full colour or a monochrome display panel.

FIG. 2 shows a part of a passive matrix display panel 2 in top view and along cross-sections A-A and B-B according to the prior art. Individual display pixels 3 in a row 4 are separated by a protection layer 6 applied on a substrate 7. The protection layer 6 isolates the anode 8 and the cathode (not shown). The protection layer 6 is further covered by a photoresist structure 9. The resist structures 9 are obtained in a standard photolithography process and subsequent elevation of the temperature above the glass temperature of the applied photoresist material in order to smoothen the structures 9. This smoothening of the resist structures 9 is required to avoid interruption of the cathode layer (not shown) along the row 4. The resist structures 9 are formed in order to contain liquid drops of electroluminescent material (not shown) and to prevent mixing of these drops between adjacent display pixels 3. Typically the height of the resist structures 9 is 1-10 microns. The liquid may e.g. be applied by ink jet printing.

The disadvantage of this solution is that a photolithographic step is necessary to form the resist structures 9. The temperature is typically increased to e.g. 200° C. to initiate some flow of the resist material in order to smoothen, i.e. curvature of the sharp edges of the photolithographically defined structure, the resist structure 9. If the substrate 7 is e.g. of plastic, considerable dimensional distortion of e.g. tens of microns may arise of the structures on the substrate 7.

In a passive matrix display panel 2 usually further resist structures 10 with a negative edge are provided to obtain separation of the cathode lines (not shown) for the adjacent rows 4. The negative edge of the resist structure 10 exerts capillary forces on the liquid drops with electroluminescent material transporting the liquid to adjacent display pixels 3. It is noted that the further resist structure 10 itself does not require appliance of high temperatures.

FIG. 3 illustrates a part of an active matrix display panel according to the prior art, wherein photoresist structures 9 are present as well to prevent the liquid comprising the electroluminescent material from mixing with adjacent display pixels 3. It is noted that the resist structures 10 with a negative edge are not required for an active matrix display panel 2 as such panels typically operate with a common cathode (not shown).

For both passive matrix display panels as shown in FIG. 2 and active matrix display panel as shown in FIG. 3, a surface treatment may be performed to vary the wetting characteristics of the various parts on the panel. An O₂ plasma treatment followed by a CF₄ plasma treatment ensures that the inkjet printed liquids, e.g. polyethylenedioxythiophene (PEDOT) and a light emitting polymer (LEP), wet the anode 8, that may be of indium tin oxide (ITO), and the protection layer 6, that may be of SiO₂, but are repelled from the organic photoresist structures 9.

FIG. 4 shows a part of a passive matrix display panel 2 in top view and along cross-section A-A according to an embodiment of the invention. The substrate 7 again comprises a protection layer 6 and an anode 8 defining display pixels 3 for emission of red (R), green (G) and blue (B) light on application of a current However, the display panel 2 no longer has resist structures 9 between the display pixels 3 as shown in FIGS. 2 and 3. Instead a microcontact printed layer 11 is provided between the display pixels 3. The microcontact printed layer 11 may have or be provided with hydrophobic characteristics as will be discussed in more detail below. Similarly for active matrix display panels 2 as shown in FIG. 3 the resist structures 9 can be replaced by microcontact printed layers 11. Preferably the microcontact printed layers 11 are applied all around the display pixels 2. It should be noted that the shape of the display pixel 2 is not limited to the one of the figure. Other pixel shapes, e.g. circular, square or rectangular are possible.

In the microcontact printing technique a stamp with a patterned stamp surface is inked with a solution comprising molecules for the printed layer 11 that diffuses into the stamp. The stamp may e.g. be of polydimethylsiloxane (PDMS). The stamp may subsequently be dried. Afterwards the patterned stamp is brought into proximity with the display panel 2 such that the protruding parts of the stamp contact the appropriate parts of the display panel. As a result the material present on the stamp is transferred to the surface of the display panel at the contacting parts leading to a microcontact printed layer 11. Microcontact printing provides significant advantages over conventional photolithographic techniques because of the increased resolution enabled by microcontact printing. Microcontact printing is characterized by extremely high resolution enabling patterns of submicron dimension to be imparted onto a surface. Microcontact printing is also more economical than photolithography systems since it is procedurally less complex and can be carried out under ambient conditions. In addition, microcontact printing permits higher throughput production than other techniques, such as e-beam lithography (a conventional technique employed where higher resolutions are desirable). Further microcontact printing can be applied to large display panels 2 while maintaining a good printing accuracy.

FIG. 5 illustrates the effect of the provision of a liquid drop 12 with electroluminescent material. The microcontact printed layer 11 has or is given a hydrophobic character repelling the liquid. A high advancing contact angle Φ of e.g. 25-60°, e.g. 50°, can be easily obtained. Such an angle is comparable to the angle achieved by employing the prior art photoresist structures 9. Thus, as the microcontact layer 11 is printed in substantially the same position as the prior art structures 9, this microcontact layer 11 is suited to perform the function of preventing mixture of drops 12 of subsequent display pixels 3 while yielding the above-mentioned advantages over the prior art

FIGS. 6A-6D show several steps of the manufacturing process according to an embodiment of the invention

In FIG. 6A a substrate 7 is provided. The substrate may e.g. be a glass substrate or a polymer substrate. The substrate may be provided with a polymer layer (not shown). In FIG. 6A further the protection layer 6 and an ITO anode 8 are applied and patterned. The thickness of the protection layer 6 can be very small. A thickness of e.g. 20 nm may be sufficient to isolate the anode 8 from the cathode (shown in FIG. 6D). The protection layer 6 can be both an inorganic layer such as SiO₂ or a photoresist layer with a low cross-linking temperature. For an active matrix display panel 2, typically the circuitry for the individual display pixels 3 (not shown) is present below the layers shown in FIGS. 6A-6D. The ITO-layer 8 has a thickness in the range of e.g. 100-200 nm. The protection layer 6 and ITO anode 8 may be given a O₂ plasma or UV ozone treatment to improve the wetting characteristics of these layers.

In FIG. 6B the layer 11 is microcontact printed or defined as described above. The microcontact printed layer 11 preferably is a self-assembling monolayer (SAM) that is e.g. 1-3 nm thick. Alternatively a thicker layer 11 may be applied which can be obtained by e.g. employing a non-dried stamp. For an SiO₂ protection layer 6 a suitable candidate monolayer is octadecyl-trichlorosilane (OTS), but preferably the monolayer has a fluor component in it. A suitable candidate for this is trimethoxy(3,3,3-trifluoropropyl)silane from Aldrich.

Alternatively the protection layer 6 is a thin polymer layer. Many polymers have their own suitable monolayer 11 with the required poor wetting characteristics. Below some material systems will described, but is should be appreciated that the invention is not in any way limited to these examples. It is noted that the layers 11 can be microcontact printed on a polymer substrate 7 as well.

Carboxylic anhydride modified polyethylene (PE) can stamped with poly(tert-butylacrylate) (PTBA) to yield polyacrylic-acid (PAA) hyperbranched films after wet chemical treatment. The PAA-film can be modified by fluorination to obtain the hydrophobic layer 11. This fluorination can be also done by a dipping technique. The interesting aspect is that the ITO will not be fluorinated and hence still have a good wetting characteristics.

Another example is the patterning of layer-by-layer polyelectrolyte stacks on hydrophilic polystyrene (hPS) by microcontact printing of polystyrene-block-polyacrylic-acid (PS-b-PAA) on the exposed polyamine layer of the polyelectrolyte stack. Substrates 7 may be provided with such stacks from the shelf A fluorination treatment may improve the hydrophobic characteristics of the microcontact printed layer 11.

Yet another example is the printing of poly(lactic acid)-poly(ethylene glycol) (PLA-PEG) on polystyrene (PS). PS itself does not have very good wetting characteristics. By microcontact printing PLA-PEG areas with good wetting characteristics can be defined, leaving non-printed PS area 13 with poor wetting characteristics. In this way a “negative printing” approach is taken as shown in FIG. 7.

As illustrated the layer 11 is defined such that parts 6A of the protection layer are exposed before deposition of the liquid with electroluminescent material. These parts 6A enable the electroluminescent material to spread homogeneously over the display pixel area as the hydrophilic parts 6A attract the liquid to the edges of the display pixel 3. The layer 11 may be given a fluorination treatment to obtain or improve the hydrophobic characteristics of this layer.

In FIG. 6C the liquid comprising the electroluminescent material 12 is applied and contained between the microcontact printed layers 11 as was already described with respect to FIG. 5.

In FIG. 6D a metallic layer 13 is applied as a cathode with a thickness of 100-200 nm. It is noted that this cathode 13 may also be transparent as required for top emission display panels 2. The invention is applicable to both bottom emission and top emission display panels.

FIG. 7 shows an example of a liquid drop comprising electroluminescent material on a display panel according to a “negative printing” embodiment of the invention. A polystyrene layer 13 is microcontact printed with poly(lactic acid)-poly(ethylene glycol) (PLA-PEG). The PS layer 13 itself does not have very good wetting characteristics. By microcontact printing PLA-PEG areas 14 with good wetting characteristics can be defined, leaving the non-printed area of the PS-layer 13 with poor wetting characteristics. In this way a “negative printing” approach is realized.

1. Electroluminescent display panel (2) comprising a substrate (7) and a plurality of display pixels (3) including an electroluminescent material defined on or over said substrate, wherein said display panel further includes at least one microcontact printed hydrophobic layer (11) between at least some adjacent display pixels (3).

2. Electroluminescent display panel (2) according to claim 1, wherein said hydrophobic layer (11) is a self-assembling monolayer.

3. Electroluminescent display panel (2) according to claim 1, wherein said substrate (7) is a flexible substrate.

4. Electroluminescent display panel (2) according to claim 1, wherein said display panel (2) further comprises first and second electrodes (8,13) for said display pixels (3) and a protection layer (6) isolating said first from said second electrodes (6,13) between said display pixels (3).

5. Electroluminescent display panel according to claim 4, wherein said microcontact printed hydrophobic layer (11) is defined on or over at least a part of said protection layer (11).

6. Electroluminescent display panel according to claim 5, wherein said microcontact printed hydrophobic layer (11) exposes a part (6A) of said protection layer (6) to said electroluminescent material (12).

7. Electric device (1) comprising an electroluminescent display panel (2) according to claim 1.

8. Method for manufacturing an electroluminescent display panel (2) comprising the steps of:
providing a substrate (7);
providing a hydrophobic layer (11) on or over said substrate by microcontact printing.

9. Method according to claim 8, wherein said method further comprises the steps of:
providing first electrodes (8) on or over said substrate (7);
providing a protection layer (6) on or over said first substrate (7);
patterning said protection layer (6) to determine display pixel areas (3);
providing said hydrophobic layer (11) between said display pixel areas (3) by microcontact printing.

10. Method according to claim, wherein said method further comprises the steps of:
depositing at least one electroluminescent material (12) over said substrate (7);
providing a metallic layer (13) on or over at least said electroluminescent material (12).

11. Method according to claim 8, wherein said hydrophobic layer is obtained by fluorinating a microcontact printed layer (11).

12. Method according to claim 8, wherein said hydrophobic layer (11) is microcontact printed on an inorganic layer, such as SiO₂ or ITO.

13. Method according to claim 12, wherein said hydrophobic layer (11) is trimethoxy(3,3,3-trifluoropropyl)silane.

14. Method according to claim 8, wherein said hydrophobic layer is microcontact printed on a polymer layer.

15. Method according to claim 14, wherein said hydrophobic layer is obtained by the steps of:
microcontact printing of poly(tert-butylacrylate) on a polyethylene layer;
wet-chemical treatment of said poly(tert-butylacrylate) to yield a polyacrylic acid hyperbranched film;
fluorination of at least a part of said polyacrylic acid hyperbranched film.

16. Method according to claim 14, wherein said hydrophobic layer is obtained by the steps of:
providing a polyelectrolyte stack of polyamine layers on a hydrophilic polystyrene layer
microcontact printing of a polystyrene-block-polyacrylic-acid on an exposed polyamine layer of said polyelectrolyte stack;
fluorination of said polystyrene-block-polyacrylic-acid.

17. Method according to claim 14, wherein said hydrophobic layer is obtained by the steps of:
providing a hydrophilic polystyrene layer;
microcontact printing of poly(lactic acid)-poly(ethylene glycol) on said polystyrene layer.
